(19) United States
(12) Patent Application Publication
(10) Pub. No.: US 2005/0144829 A1
(43) Pub. Date: Jul. 7, 2005

(54) Fishing pole holder and method

(76) Inventor: Fernando Gonzalez, Naples, FL (US)

Correspondence Address: EDWARD M. LIVINGSTON, PA, 963 TRAIL TERRACE DRIVE, NAPLES, FL, 34103, US

(21) Appl. No.: 10/748,320

(22) Filed: Dec. 30, 2003

(51) Int. Cl. A01K 97/10

(52) U.S. Cl. 43/21.2

(57) ABSTRACT

A fishing pole holder which allows fishermen and fisherwomen to maintain the ideal fishing line angle while fishing without having to hold his or her fishing pole. The fishing pole holder has a holder (1) that is cylindrically shaped and hollow for the acceptance of a handle of a fishing pole (4). A cylindrically shaped and hollow base pole (2) can be fixably or removably attached to the holder (1) at a ninety degree angle. The base pole (2) has a pointed end (3) to allow easy insertion into a ground (5). To use the fishing pole holder, the user simply takes the holder and inserts the pointed end (3) of the base pole (2) into the ground (5) at an angle so that the fishing pole holder is leaning away from the water. The user then places the handle of his or her fishing pole (4) into the holder (1).

### BACKGROUND OF THE INVENTION

This invention relates to fishing pole holders, more specifically, a fishing pole holder that maintains the preferred fishing line angle when retaining a fishing pole.

Fishing has been a long-time favorite outdoor activity for many. The calming water, the peace and quiet and simplistic nature of the sport entice all people, from young and old to novice and professionals, to get outside and go fishing.

Without a doubt the most exciting part of fishing is when a person gets a bite on his or her fishing line and reels in the catch. The time leading up to that ultimate moment, however, is at the least, uneventful. Although most of the time spent fishing is actually time spent waiting, standing in one place, holding a fishing rod and waiting for a bite is not the reason why people go fishing. Not only is the waiting process boring, but it can be tiresome if a person is standing in one place, holding his or her fishing pole. Thus, fishing pole holders are commonly used by fishermen and fisherwomen.

Additionally, many fishermen and fisherwomen also prefer to use several fishing poles at once, thereby increasing the odds of catching a fish. Thus, increasing the popularity of fishing pole holders.

Currently, there are many fishing pole holders that maintain the fishing pole in an upright position in order to allow the user to perform other activities or use several fishing poles at once. However, a major disadvantage to using the current fishing pole holders is that the holders do not maintain the ideal fishing line angle when being used. Either the fishing pole is inserted into a holder wherein the pole is perpendicular to the ground or the fishing pole is inserted into a holder that leans towards the water. Although the pole holders will adequately hold the poles, the fishing line angle is compromised because the line is entering the water at either a too high angle or too low angle. If a less than ideal fishing line angle is used, the chances of hooking a fish are drastically reduced. Further disadvantages of present holders include that they cannot hold fishing poles with long handles and there is a high risk of losing one's pole when a fish is hooked, especially with a large fish.

Thus, the need exists for a device which holds a fishing pole in place without compromising the ideal fishing line angle desired.

The relevant prior art includes the following patents:

| Patent No. | | |
|---|---|---|
| (U.S. unless stated otherwise) | Inventor | Issue Date |
| 3,360,224 | Baumann, Jr. | Dec. 26, 1967 |
| Des. 245,423 | Tentler | Aug. 16, 1977 |
| Des. 349,555 | Siket, Jr. et al. | Aug. 09, 1994 |
| Des. 409,274 | Morse, Jr. et al. | May 04, 1999 |
| 2,952,432 | Valdez | Sep. 13, 1960 |
| Des. 303,564 | Ewald | Sep. 19, 1989 |
| 5,383,299 | Smelker | Jan. 24, 1995 |
| Des. 179,525 | Porter | Jan. 08, 1957 |

Although the above patents teach various types of fishing pole holders, none teach a fishing pole holder designed to maintain the ideal fishing line angle by providing a T-shaped holder that is designed to lean away from the water.

### SUMMARY OF THE INVENTION

The primary object of the present invention is to provide a fishing pole holder that can hold a fishing pole while maintaining an ideal fishing line angle.

A further object of the present invention is to provide a fishing pole holder that slants away from the water when anchored into the ground.

An even further object of the present invention is to provide a fishing pole holder that can accommodate fishing poles of various lengths and widths.

A further object of the present invention is to provide a fishing pole holder that is easy to insert into sand.

An even further object of the present invention is to provide a fishing pole holder that is strong enough to support large fish when caught.

A further object of the present invention is to provide a fishing pole holder that can be disassembled for easy transportation and storage.

The present invention fulfills the above and other objects by providing a fishing pole holder comprised of two components: a holder and a base pole. The holder is cylindrically shaped so as to accommodate the handle of a fishing pole and can be fixably attached or removably attached to the base pole at a predetermined angle, preferably a ninety degree angle. The base pole has a pointed end and is also cylindrically shaped. The diameter of the base pole is smaller than the diameter of the holder so as to promote easy insertion into the ground. Additionally, both components are preferably made of a durable and weatherproof material, preferably PVC pipe.

To use the present invention, the user first inserts the pointed end of the base pole into the ground so the pole is leaning away from the water. The preferable angle of insertion of the pole is an angle of approximately 125 degrees leaning away from the water. If using the invention wherein the pole holder is removably attached to the base pole, the user then places the attachment piece located on the bottom of the pole holder piece onto the base pole. The user then casts his fishing line and inserts the handle end of the fishing pole into the holder. Because the device is anchored at an angle, the fishing pole will be held at an angle as well, thus maintaining the ideal fishing line angle.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of the fishing pole holder of the present invention in use;

FIG. 2 is a front view of the present invention;

FIG. 3 is an upward view of the embodiment of FIG. 2; and

FIG. 4 is a side view of an alternate embodiment of the fishing pole holder wherein an attachment piece is used.

### DESCRIPTION OF THE PREFERRED EMBODIMENTS

For purposes of describing the preferred embodiment, the terminology used in reference to the numbered components in the drawings is as follows:

| | |
|---|---|
| 1. | holder |
| 2. | base pole |
| 3. | pointed end |
| 4. | fishing pole |
| 5. | ground |
| 6. | attachment piece |

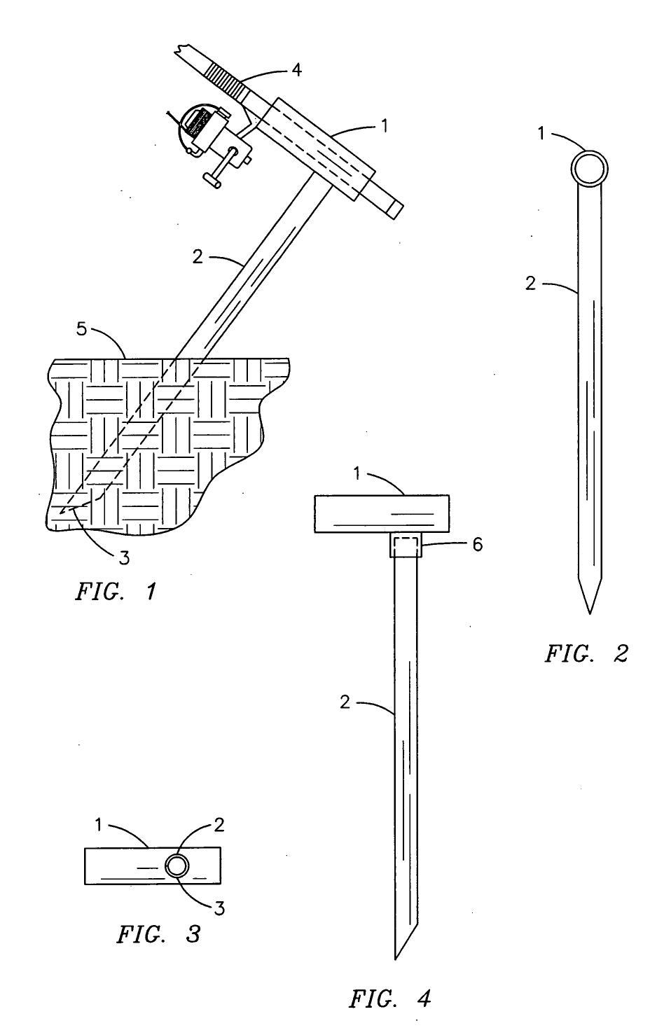

With reference to FIG. 1, a side view of the present invention in use is shown. The fishing pole holder has a holder 1, preferably made of PVC pipe, and a base pole 2, also preferably made PVC pipe. The holder 1 and the base pole 2 are connected so that a ninety degree angle is formed between the two components. The base pole 2 has a pointed end 3 for easy insertion into the ground 5. A fishing pole 4 handle fits into the cylindrically shaped holder 1.

In FIG. 2, a front view of the present invention is shown. The holder 1 has a predetermined diameter and is hollow to allow for the acceptance of various sized fishing pole handles.

In FIG. 3, an upward looking view of the present invention is shown. The base pole 2 is hollow so as to permit better anchoring of the fishing pole holder by allowing the ground to be within and surround the base pole 2.

With reference to FIG. 4, an alternate embodiment of the present invention is shown wherein an attachment piece 6 is used. Rather than having the holder 1 fixably attached to the base pole 2, a hollow attachment piece 6 is attached to the underside of the holder 1. The attachment piece 6 has a diameter slightly larger than the diameter of the base pole 2 so as to fit snugly over the end of the base pole 2. When the user is finished using the fishing pole holder, he or she can simply detach the holder 1 from the base pole 2 for compact storage.

The use of the present invention will allow fishermen and fisherwomen the ability to keep fishing at an ideal fishing angle without holding the fishing pole.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

1. A fishing pole holder comprising:
a hollow cylindrically shaped holder having an open first end and an open second end;
a cylindrically shaped base pole having a first end and a second end;
said base pole having a predetermined diameter;
said base pole second end is pointed:
said base pole is hollow: and
a means for attaching said base pole first end to a predetermined location between said holder first end and said holder second end at a substantially perpendicular angle.

2. The fishing pole holder of claim 1 wherein:
said holder is made of PVC pipe.

3. The fishing pole holder of claim 1 wherein:
said base pole is made of PVC pipe.

4. (canceled)

5. The fishing pole holder of claim 1 wherein:
said means for attaching is glue.

6. The fishing pole holder of claim 1 wherein:
said means for attaching is tape.

7. The fishing pole holder of claim 1 wherein:
said means for attaching is via an attachment piece fixably secured to said holder between said holder first end and said holder second end;
said attachment piece is cylindrically shaped;
said attachment piece is hollow; and
said attachment piece has a diameter sized slightly larger than said base pole diameter.

8. The fishing pole holder of claim 7 wherein:
said attachment piece is made of PVC pipe.

9. A method of using a fishing pole holder comprising a hollow cylindrically shaped holder having an open first end and an open second end; a cylindrically shaped hollow base pole having a first end and a second end; said base pole having a predetermined diameter; said base pole second end is pointed: and a means for attaching said base pole first end to a predetermined location between said holder first end and said holder second end at a substantially perpendicular angle, said method comprising the steps of:
a. inserting said pointed second end of said base pole into a ground surface at an angle so that the fishing pole holder is leaning away from the water; and
b. inserting a fishing pole handle into said holder.

10. The method claimed in claim 9 wherein:
said means for attaching is via an attachment piece fixably secured on said holder between said holder first end and said holder second end; and
said attachment piece has a diameter sized slightly larger than said base pole diameter.

11. The method claimed in claim 10 further comprising the step prior to step b of:
placing said attachment piece diameter on said base pole first end.
